(19) United States
(12) Patent Application Publication
(10) Pub. No.: US 2020/0057707 A1
(43) Pub. Date: Feb. 20, 2020

(54) Methods and apparatus for full-system performance simulation

(71) Applicant: ALIBABA GROUP HOLDING LIMITED, George Town (KY)

(72) Inventor: Xiaowei Jiang, San Mateo, CA (US)

(21) Appl. No.: 15/999,157

(22) Filed: Aug. 17, 2018

(51) Int. Cl. G06F 11/34; G06F 11/26; G06F 9/38

(52) U.S. Cl. CPC G06F 11/3457; G06F 9/3802; G06F 11/261

(57) ABSTRACT

The present application provides methods and systems for simulating full-system performance of a hardware device. An exemplary system for simulating full-system performance of a hardware device may include a cycle-accurate performance simulator configured to model a performance of a hardware component of a plurality of hardware components of a system, and the cycle-accurate performance simulator may include a first transactor. The system may also include a full-system simulator configured to model a performance of the plurality of hardware components of the system, and the full-system simulator includes a second transactor. The system may further include a communication mechanism between the first transactor and the second transactor, wherein the communication mechanism is configured to communicate data between the cycle-accurate performance simulator and the full-system simulator.

### BACKGROUND

Silicon design involves various levels of simulations through appropriate simulators to facilitate efficient design and development of a hardware component. The simulators may help hardware architects to evaluate potential hardware architecture and help register transistor level (RTL) designers to determine whether potential hardware implementation matches behaviors and performance requirements of the hardware component. Throughout a complete design flow, architects and RTL designers may perform simulations using various simulators, such as functional simulators, cycle-accurate performance simulators, full-system simulators or emulators, and full-system performance simulators. These simulators are generally developed and designed for different simulation purposes at different phases of the design flow.

For example, architects and RTL designers may need to sequentially perform functional simulations, cycle-accurate performance simulations, full-system simulations, and full-system performance simulations. The architects and RTL designers therefore need to design and develop functional simulators, cycle-accurate performance simulators, full-system simulators, and full-system performance simulators, respectively. But the developing and designing of each of these simulators is time- and resource-consuming process.

### SUMMARY

Embodiments of the present disclosure provide improved methods and systems for full-system performance simulation.

These embodiments include a system for simulating full-system performance of a hardware device. The system may include a cycle-accurate performance simulator configured to model performance of a hardware component of a plurality of hardware components of a system, and the cycle-accurate performance simulator may include a first transactor. The system may also include a full-system simulator configured to model performance of the plurality of hardware components of the system, and the full-system simulator may include a second transactor. The system may further include a communication mechanism between the first transactor and the second transactor. The communication mechanism may be configured to communicate data between the cycle-accurate performance simulator and the full-system simulator.

These embodiments also include a method for simulating full-system performance of a hardware device. The method may include performing a cycle-accurate performance simulation of the hardware device. The method may also include performing a full-system simulation of the hardware device. The method may further include communicating between the cycle-accurate performance simulation and the full-system simulation through inter-process communication.

These embodiments further include a non-transitory computer-readable medium storing a set of instructions that are executable by one or more processors of an apparatus to cause the apparatus to perform a method for simulating full-system performance of a hardware device. The method may include performing a cycle-accurate performance simulation of the hardware device. The method may also include performing a full-system simulation of the hardware device. The method may further include communicating between the cycle-accurate performance simulation and the full-system simulation through inter-process communication.

It is to be understood that the foregoing general description and the following detailed description are exemplary and explanatory only, and are not restrictive of the invention, as claimed.

### BRIEF DESCRIPTION OF THE DRAWINGS

Reference will now be made to the accompanying drawings showing exemplary embodiments of this disclosure. In the drawings:

FIG. 1 is a schematic diagram of an exemplary full-system performance simulator, according to some embodiments of the present disclosure.

FIG. 2 is a schematic diagram of an exemplary process for synchronizing a cycle-accurate performance simulator and a full-system simulator, according to some embodiments of the present disclosure.

FIG. 3 is a schematic diagram of an exemplary process for performing a memory read operation between a cycle-accurate performance simulator and a full-system simulator, according to some embodiments of the present disclosure.

FIG. 4 is a schematic diagram of an exemplary process for performing one or more memory read operations between a cycle-accurate performance simulator and a full-system simulator, according to some embodiments of the present disclosure.

FIG. 5 is a flow chart of an exemplary method for simulating full-system performance of a hardware device, according to some embodiments of the present disclosure.

FIG. 6 illustrates a block diagram of an exemplary apparatus for simulating full-system performance of a hardware device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The embodiments described herein shorten the overall design cycle of a simulator. For example, an aspect of the disclosure is directed to a non-transitory computer-readable medium storing a set of instructions that are executable by one or more processors of an apparatus to cause the apparatus to perform a method for simulating full-system performance of a hardware device. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

When the non-transitory computer-readable medium storing the set of instructions is executed, the one or more processors of the apparatus can cause the apparatus to perform the following methods for simulating full-system performance of the hardware device.

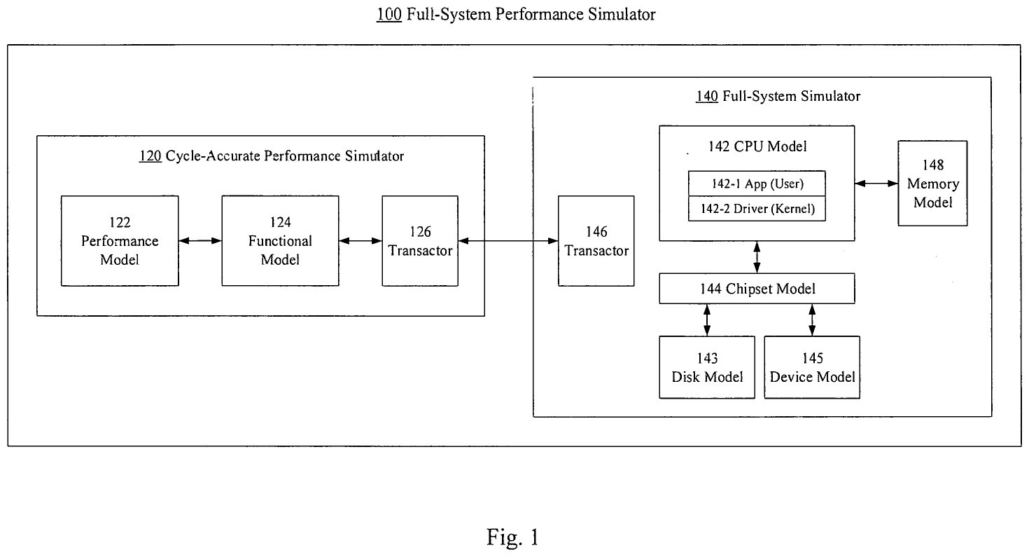

FIG. 1 is a schematic diagram of an exemplary full-system performance simulator 100, according to some embodiments of the present disclosure. Full-system performance simulator 100 can simulate a hardware device, such as a central processing unit (CPU). As shown in FIG. 1, full-system performance simulator 100 includes a cycle-accurate performance simulator 120 and a full-system simulator 140.

As shown in FIG. 1, cycle-accurate performance simulator 120 includes a performance model 122, a functional model 124, and a transactor 126. Cycle-accurate performance simulator 120 may perform cycle-accurate performance simulations of the CPU in cycles in accordance with performance model 122. In some embodiments, cycle-accurate performance simulator 120 may simulate each operation that the CPU performs in each cycle. Cycle-accurate performance simulator 120 can be either trace-driven or execution-driven. When cycle-accurate performance simulator 120 is trace-driven, cycle-accurate performance simulator 120 may use traces to stimulate performance model 122 to perform cycle-accurate performance simulations. When cycle-accurate performance simulator 120 is execution-driven, cycle-accurate performance simulator 120 may validate correctness of execution results of simulations from performance model 122 in accordance with functional model 124.

Before cycle-accurate performance simulator 120 starts to perform cycle-accurate performance simulation of the CPU, cycle-accurate performance simulator 120 may load initial contexts of registers of the CPU. For example, cycle-accurate performance simulator 120 may load initial values of general-purpose registers, segmentation registers, control registers, floating point registers, streaming SIMD single instruction multiple data (SIMD) extensions (SSE) registers, CPU identification (CPUID) registers, model-specific registers (MSRs) of the CPU.

As shown in FIG. 1, full-system simulator 140 includes a CPU model 142, a disk model 143, a chipset model 144, a device model 145, a transactor 146, and a memory model 148. Full-system simulator 140 includes an entire system in which the CPU is applied to and models functionality of the entire system. CPU model 140 includes an application model 142-1 modeling a user process and a driver model 142-2 modeling an operating system (OS) kernel. As shown in FIG. 1, full-system simulation 140 includes an entire computer system that the simulated CPU is applied to. In some embodiments, full-system simulator 140 may include a server system or a system on chip (SoC) system to which the hardware device is applied to.

When full-system performance simulator 100 performs full-system performance simulation of the CPU, cycle-accurate performance simulator 120 and full-system simulator 140 may respectively perform cycle-accurate performance simulation and full-system simulation, and communicates with each other through transactors 126 and 146. For example, when cycle-accurate performance simulator 120 may use full-system simulator 140 to fetch instructions, transactor 126 may send a request for instruction fetch to transactor 146. After full-system simulator 140 fetches the instructions, transactor 146 may then send the fetched instructions to transactor 146 for cycle-accurate performance simulator 120 to proceed with the cycle-accurate performance simulation.

Cycle-accurate performance simulator 120 and full-system simulator 140 may operate as different processes in an operating system. Transactors 126 of cycle-accurate performance simulator 120 and transactor 146 of full-system simulator 140 can communicate with each other through inter-process communication (IPC) mechanisms, including shared memory, pipes, and a portable operating system interface (POSIX). The shared memory may be, for example, a shared memory space used for handshaking between transactors 126 and 146. Both transactors 126 and 146 can access the shared memory space. The pipes may be used for massive data transmission between transactors 126 and 146, such as instructions or application data transmission between cycle-accurate performance simulator 120 and full-system simulator 140. The POSIX may be used to send requests or responses between transactors 126 and 146.

When full-system performance simulator 100 perform full-system performance simulation of the CPU, transactors 126 and 146 may communicate through four different pipes between each other. Two pipes can be used for read or write requests between cycle-accurate performance simulator 120 and full-system simulator 140. The other two pipes can be used for synchronization of data transmission in the two pipes used for read or write requests between cycle-accurate performance simulator 120 and full-system simulator 140.

For example, when cycle-accurate performance simulator 120 performs cycle-accurate performance simulation of the CPU, cycle-accurate performance simulator 120 may request to fetch an instruction from full-system simulator 140. Accordingly, transactor 126 may write a program counter (PC) of the instruction into a write pipe, e.g., a first write pipe. Transactor 126 may also set a request type as being FetchInst in the shared memory. The FetchInst is an instruction-fetch type of request types. Transactor 126 may further send a signal through the POSIX to transactor 146, and then spin on a synchronization pipe, e.g., a first synchronization pipe for synchronizing data transmission in the first write pipe.

On the other hand, transactor 146 may include a signal handler that is used for handling the signal sent through the POSIX. Transactor 146 may read the request type, e.g., FetchInst, from the shared memory and extract the fetch PC from the first write pipe. The FetchInst is an instruction-fetch type of request types. When the signal through the POSIX arrives at transactor 146, transactor 146 may read a fetch block of the instruction from memory of the simulated computer system in accordance with the PC and the request type. As shown in FIG. 1, The memory of the simulated computer system can be memory model 148. Transactor 146 may write the fetch block of the instruction to a write pipe of transactor 146, e.g., a second write pipe. Transactor 146 may then send a message in the first synchronization pipe that transactor 126 spins on. After receiving the message, transactor 126 may stop spinning on the first synchronization pipe and read the fetch block of the instruction from the second write pipe. Transactor 126 may also send a message in a second synchronization pipe to notify transactor 146 that the sent fetch block has been received. The second synchronization pipe is for synchronizing data transmission in the second write pipe. Accordingly, cycle-accurate performance simulator 120 may receive the instruction in the fetch block of the instruction.

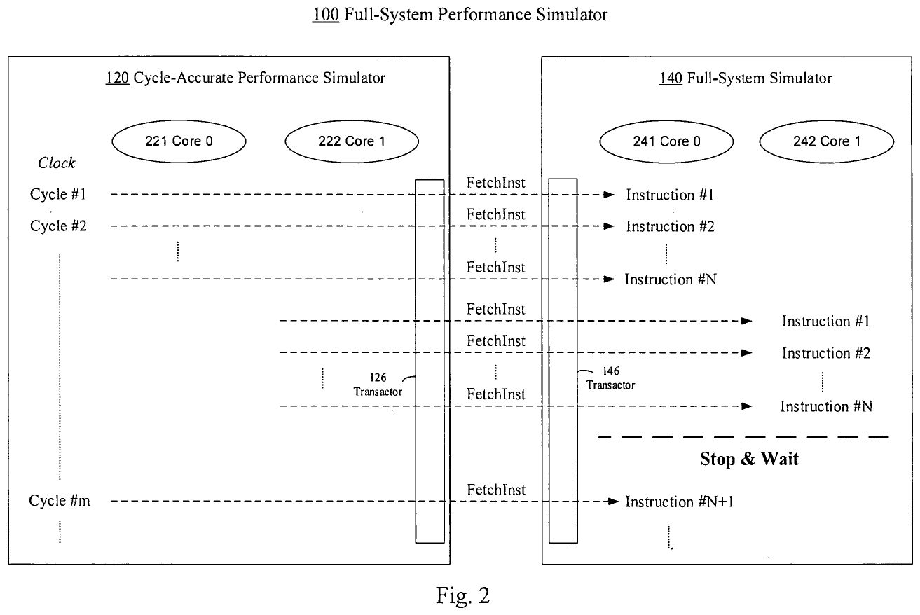

FIG. 2 is a schematic diagram of an exemplary process for synchronizing cycle-accurate performance simulator 120 and full-system simulator 140, according to some embodiments of the present disclosure. As shown in FIG. 2, full-system performance simulator 100 of the CPU includes cycle-accurate performance simulator 120 and full-system simulator 140. Cycle-accurate performance simulator 120 includes a core 221 and a core 222 of the CPU. Full-system simulator 140 includes a core 241 and a core 242 of the CPU.

Cycle-accurate performance simulator 120 may include a global variable Clock that stands for a clock cycle. In each clock cycle, the variable Clock increases and cycle-accurate performance simulator 120 may perform cycle-accurate performance simulation of the CPU for one clock cycle. Thus, each processing unit in pipelines of cores 221 and 222 may execute instructions of the CPU to perform the cycle-accurate performance simulation of the CPU for one clock cycle forward.

On the other hand, full-system simulator 140 may perform a full-system simulation of the CPU in accordance with instructions. For example, full-system simulator 140 may perform a full-system simulation of the CPU to execute at least one instruction as a simulation-progress unit. When full-system simulator 140 performs the full-system simulation of the CPU, full-system simulator 140 may simulate that core 241 executes a number of instructions and then that core 242 executes another number of instructions. Then core 241 executes another number of instructions and so does core 242. Thus, cores 241 and 242 may execute a plurality of instructions in turns.

Because of the high complexity of the cycle-accurate performance simulation, cycle-accurate performance simulator 120 may perform the cycle-accurate performance simulation slower than that of full-system simulator 140. Cycle-accurate performance simulator 120 and full-system simulator 140 may synchronize with each other through transactors 126 and 146 (shown in FIG. 1) during the full-system performance simulation.

For example, as shown in FIG. 2, transactor 146 may request full-system simulator 140 to stop the full-system simulation and wait for cycle-accurate performance simulation after each of cores 241 and 242 executes a number of instructions. For example, transactor 146 may request full-system simulator 140 to stop and wait for cycle-accurate performance simulator 120 after cores 241 and 242 each execute N instructions. After cycle-accurate performance simulator 120 performs a plurality of clock cycles that amount to the 2N instructions executed by full-system simulator 140, cycle-accurate performance simulator 120 may catch up simulation progress with that of full-system simulator 140. Full-system simulator 140 can then perform the full-system simulation for another amount of instructions, such as another 2N instructions.

When full-system simulator 140 waits for cycle-accurate performance simulator 120, transactor 126 of cycle-accurate performance simulator 120 may send requests and/or signals for various functions to transactor 146 of full-system simulation 140. Transactor 146 may serve these requests and provide results or responses to transactor 126. For example, transactor 126 may send a request for instruction fetch or memory access to transactor 146. Transactor 146 may handle the request for instruction fetch or memory access and send a fetched instruction or accessed data back to transactor 126. Cycle-accurate performance simulator 120 can proceed with the cycle-accurate simulation in accordance with the fetched instruction or accessed data. When cycle-accurate performance simulator 120 catches up simulation progress with that of full-system simulator 140, transactor 146 may request full-system simulator 140 to resume performing the full-system simulation.

In some embodiments, transactor 146 may include a buffer to store instructions that have been executed in the full-system simulation. When transactor 146 receives a request to fetch an instruction from transactor 126, transactor 146 may determine whether a PC of the instruction matches a PC in the first entry of the buffer. In response to a determination that the PC of the instruction matches the PC in the first entry of the buffer, transactor 146 may transmit all instructions stored in the buffer to transactor 126. Specifically, when the received PC of the instruction matches the PC in the first entry of the buffer, transactor 146 may treat the PC of the instruction as being from a correct path in instruction execution. Accordingly, transactor 146 may perform a bulk instruction fetch from the buffer and send to transactor 126. In some embodiments, in response to the determination that the PC of the instruction matches the PC in the first entry of the buffer, transactor 146 may transmit the instruction and another instruction stored in the buffer to transactor 126.

In response to a determination that the received PC of the instruction does not match the PC in the first entry of the buffer, transactor 146 may treat the PC of the instruction as being from a mispredicted path in instruction execution. The instruction to be fetched may not be in the buffer. Thus, transactor 146 may read the instruction from memory of full-system simulator 140 and send to transactor 126. For example, transactor 146 may read the instruction from memory model 148 shown in FIG. 1. Such an instruction fetch may be a single instruction fetch.

Transactor 126 may also include a buffer that stores instructions received in a bulk instruction fetch. Accordingly, transactor 126 may not need to send additional requests or signals through IPC to transactor 146 for instruction fetch when there are instructions remained in the buffer. However, when cycle-accurate performance simulator 120 requests to fetch an instruction that is in a wrong-path of instruction execution, transactor 126 may send another request and a signal through IPC to transactor 146 to fetch a correct instruction.

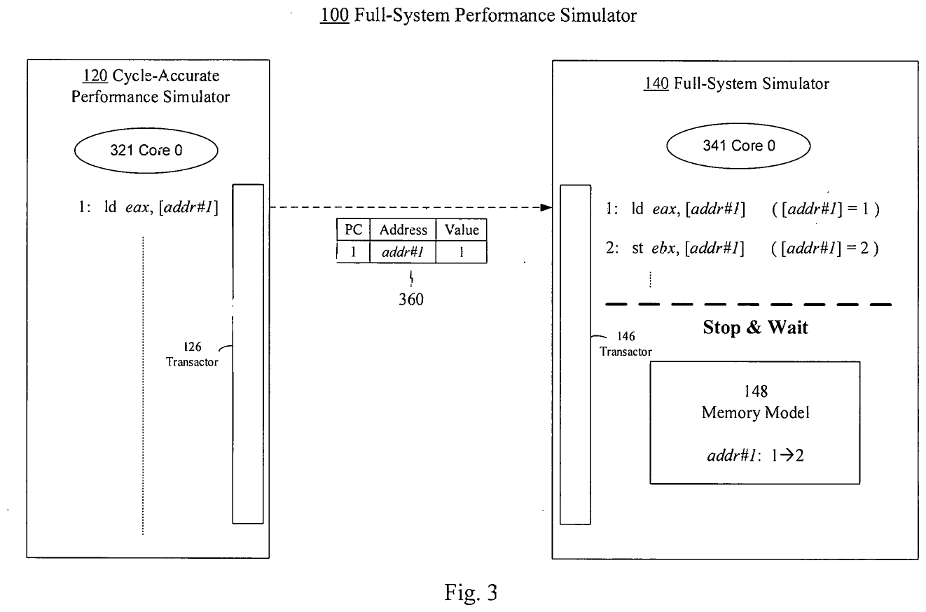

FIG. 3 is a schematic diagram of an exemplary process for performing a memory read operation between cycle-accurate performance simulator 120 and full-system simulator 140, according to some embodiments of the present disclosure. As shown in FIG. 3, full-system performance simulator 100 of the CPU includes cycle-accurate performance simulator 120, full-system simulator 140, and a memory read buffer 360. Cycle-accurate performance simulator 120 includes a core 321 of the CPU. Full-system simulator 140 includes a core 341 of the CPU.

Cycle-accurate simulator 120 may not store all contexts of an entire memory due to the volume of the memory. On the other hand, full-system simulator 140 may store all contexts of the entire memory for full-system performance simulation. Transactor 126 of cycle-accurate simulator 120 may send to transactor 146 of full-system simulator 140 a request for memory read, e.g., a ReadMemory request, when cycle-accurate performance simulator 120 executes an instruction of memory read. Transactor 126 may also send a request for memory read to transactor 146 when a page table walk is used for a page translation due to a translation lookaside buffer (TLB) miss in cycle-accurate performance simulation.

But full-system simulator 140 may not store pipeline stages for fetch, execution, and commit of an instruction because full-system simulator 140 perform full-system simulation of the CPU using an instruction as a simulation-progress unit. Therefore, an effect of an instruction can be immediately propagated to a memory hierarchy. As the illustrated methods in FIG. 2, full-system simulator 140 may perform a simulation ahead of a simulation performed by cycle-accurate performance simulator 120. In some embodiments, full-system simulator 140 may need to stop and wait for cycle-accurate performance simulator 120 to catch up with simulation progress. Hence, when transactor 126 sends a ReadMemory request for executing an instruction in an early clock cycle, full-system simulator 140 may have changed a value in an entry of memory that transactor 126 intends to read.

As shown in FIG. 3, core 341 may firstly execute a load instruction to load a value of 1 from addr #1 to eax, e.g., ld eax, [addr #1]. Core 341 may then execute a store instruction to change the value of addr #1 to 2, e.g., st ebx, [addr #1]. As noted above, full-system simulator 140 may update the value of addr #1 from 1 to 2 immediately in memory model 148. After full-system simulator 140 performs one round of simulation on each core of the CPU, transactor 146 may request full-system simulator 140 to stop simulation and wait for cycle-accurate performance simulator 120 to catch up with the simulation progress. Transactor 126 may send a ReadMemory request for the first load instruction to obtain a value of addr #1 for its cycle-accurate performance simulation. Because the value of addr #1 stored in memory model 148 of full-system simulator 140 has been changed, transactor 146 may need to serve the ReadMemory request by another means.

For example, as shown in FIG. 3, full-system performance simulator 100 may include memory read buffer 360 for storing a value, a PC, and an address that a load instruction refers to in memory of full-system simulator 140. When transactor 146 serves the ReadMemory request, transactor 146 may read from memory read buffer 360 the value of addr #1, rather than read from memory model 148. Accordingly, transactor 146 of full-system simulator 140 may provide cycle-accurate performance simulator 120 the correct value of addr #1 for the load instruction using memory read buffer 360.

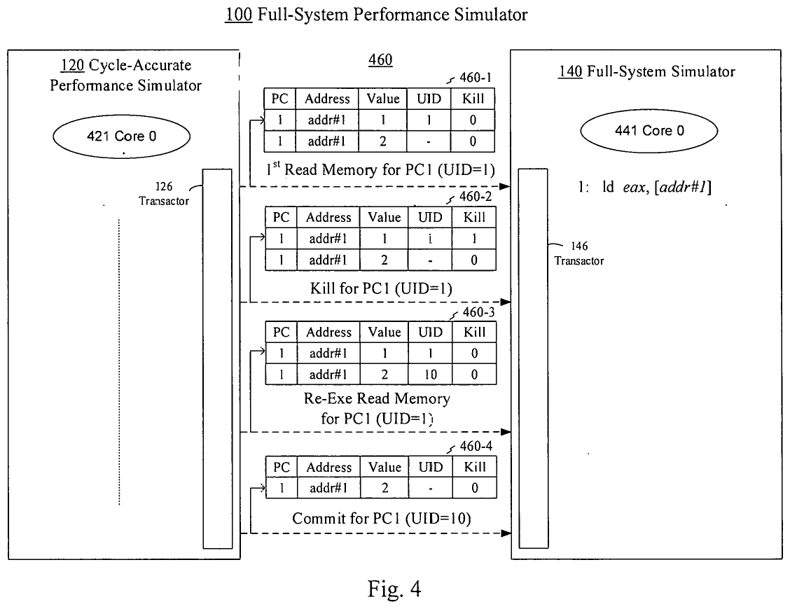

FIG. 4 is a schematic diagram of an exemplary process for performing one or more memory read operations between cycle-accurate performance simulator 120 and full-system simulator 140, according to some embodiments of the present disclosure. As shown in FIG. 4, full-system performance simulator 100 of the CPU includes cycle-accurate performance simulator 120, full-system simulator 140, and a memory read buffer 460 in four states 460-1, 460-2, 460-3, and 460-4. Cycle-accurate performance simulator 120 includes a core 421 of the CPU. Full-system simulator 140 includes a core 441 of the CPU.

When cycle-accurate performance simulator 120 performs cycle-accurate performance simulation of the CPU to execute speculative instructions, cycle-accurate performance simulator 120 may squash execution of the speculative instructions, or squash and re-execute the speculative instructions. When cycle-accurate performance simulator 120 re-executes an instruction, cycle-accurate performance simulator 120 may revisit an entry of memory read buffer 360. Accordingly, transactor 126 of cycle-accurate performance simulator 120 may send a MemoryRead request and related signals to transactor 146 of full-system simulator 140 as methods illustrated in FIG. 3. After cycle-accurate performance simulator 120 executes a first load instruction and a store instruction, cycle-accurate performance simulator 120 may execute a second load instruction of the same PC to read a value of 2 from memory of full-system simulator 140. Accordingly, as shown in FIG. 4, memory read buffer 460-1 may include two entries: {PC=1, addr #1, value=1} and {PC=1, addr #1, value=2}.

When transactor 126 sends a ReadMemory request to transactor 146, transactor 146 may read a value stored in the first entry of memory read buffer 460-1 in response to the first ReadMemory request. However, when transactor 146 receives a second ReadMemory request, transactor 146 may determine whether to read the first entry or the second entry of memory read buffer 460-1. The second ReadMemory request can be the second load instruction or a re-executed first load instruction after being squashed. When the second ReadMemory request is the second load instruction, transactor 146 may read the value of 2 from the second entry of memory read buffer 460-1. But when the second ReadMemory request is the re-executed first load instruction, transactor 146 may read the value of 1 from the first entry of memory read buffer 460-1.

Full-system performance simulator 100 may assign each instruction in full-system performance simulation of the CPU a unique instruction identifier (UID) for identification among other instructions. For example, cycle-accurate performance simulator 120 and full-system simulator 140 may respectively assign each instruction that the simulated CPU in their simulations is going to perform a UID. As another example, transactors 126 and 146 may respectively assign each instruction that the simulated CPU in their simulations is going to perform a UID. As shown in FIG. 4, memory read buffer 460 may also include a UID field and a Kill field. When cycle-accurate performance simulator 120 simulates the CPU to perform an instruction, transactor 126 may send to transactor 146 a ReadMemory request, a UID of the instruction, a PC and an address of memory. After transactor 146 receives the ReadMemory request, the PC, the address of memory, and the UID, transactor 146 may check whether the received PC, address, and UID matches those in the first entry of memory read buffer 460-1.

For example, as shown in FIG. 4, transactor 146 may store the UID of the first load instruction as being 1 in the first entry of memory read buffer 460-1. After receiving the ReadMemory request, the PC, the address, and the UID of the first load instruction, transactor 146 may determine whether the received PC, address, and UID match those in the first entry of memory read buffer 460-1. When transactor 146 determines that the received PC, address, UID matches those in the first entry of memory read buffer 460-1, transactor 146 may read the value of 1 from the first entry of memory read buffer 460-1 and send to transactor 126.

When cycle-accurate performance simulator 120 squashes the first load instruction, transactor 126 may send a message to transactor 146 to set a Kill field of the first entry of memory read buffer 460 of memory read buffer 460-1. The message may include a UID of the first load instruction. Transactor 146 may set the Kill field to a value of 1 in accordance with the UID, as memory read buffer 460-2 shown in FIG. 4. When the Kill field is set, transactor 146 may reuse the first entry for the next request of the same PC and UID. When transactor 146 receives another ReadMemory request, a PC, an address, and a UID, transactor 146 may check these parameters and the Kill field of the first entry of memory read buffer 460. Transactor 146 may read a value from the first entry of memory read buffer 460 if the received PC, address, and UID match those in the first entry and the Kill field of the first entry is set.

For example, as shown in FIG. 4, when cycle-accurate performance simulator 120 squashes the first load instruction, transactor 126 may send a message to transactor 146 to set the Kill field of the first entry of memory read buffer 460 as memory read buffer 460-2. The cycle-accurate performance simulator 120 may then re-execute the first load instruction, and send another ReadMemory request, a PC, an address, and a UID=1 to transactor 146. Since the Kill field of the first entry of memory read buffer 460-2 is set, transactor 146 may read the value of 1 from the first entry of memory read buffer 460-2 after checking the PC, address, and UID. After transactor 146 reads the value from the first entry and sends the value to transactor 126, transactor 146 may reset the Kill bit in the first entry of memory read buffer 460-2. Accordingly, memory read buffer 460 may include contexts as shown in memory read buffer 460-3.

When cycle-accurate performance simulator 120 commits the first load instruction of UID=1 or a second load instruction of UID=10 for PC=1, transactor 126 may send a message including the UID of the commited load instruction to transactor 146. Transactor 146 may de-allocate the first entry of memory read buffer 460-3 after transactor 146 determines that the received UID matches the UID of the first entry or that the load instruction of the received UID is a correct instruction to proceed with in the full system performance simulation. Accordingly, the contexts of memory read buffer 460 may change from memory read buffer 460-3 to memory read buffer 460-4.

When an interrupt occurs in full-system simulation of the CPU, full-system simulator 140 may then detect the interrupt and inform cycle-accurate performance simulator 120 to change an execution path in cycle-accurate performance simulation of the CPU. For example, cycle-accurate performance simulator 120 may change its execution path to a PC of an interrupt handler.

Accordingly, transactor 146 may parse an interrupt descriptor table (IDT) in memory, extract PCs of interrupt handlers and vectors for each interrupt registered by an operating system (OS), and store them in an IDT list. When full-system simulator 140 performs a simulation of the CPU to execute an instruction, transactor 146 may compare a PC of the executed instruction with one or more of PCs in the IDT list. When the PC of the executed instruction matches one of PCs in the IDT, transactor 146 may determine that an interrupt occurs. Thus, transactor 146 may send an interrupt-occurrence message to notify transactor 126 for handling the interrupt. The interrupt-occurrence message may indicate that an interrupt occurs when the CPU executes the instruction. In some embodiments, transactor 146 may send the interrupt occurrence message along with a next FetchInst request to transactor 126.

In another aspect, when cycle-accurate performance simulator 120 performs a simulation of the CPU to execute an instruction, cycle-accurate performance simulator 120 may be able to detect an exception. Thus, when full-system simulator 140 performs a simulation of the CPU to execute an instruction and cause an exception, transactor 146 may not notify transactor 126 an occurrence of the exception.

When full-system simulator 140 performs a full-system simulation of the CPU and needs input or output (I/O) access in the full-system simulation of the CPU, transactor 146 may need to notify cycle-accurate performance simulator 120 the occurrence of the I/O access. Accordingly, transactor 146 may detect the I/O access occurred in the full-system simulation and sent a message to transactor 126 to notify cycle-accurate performance simulator 120. In some embodiments, transactors 126 and 146 may handle a memory-mapped I/O access by the methods shown in FIG. 3 or 4 and illustrated above for handling a load instruction using a memory read buffer.

In some embodiments, transactors 126 and 146 may also handle an I/O access through a port by the methods shown in FIG. 3 or 4 and illustrated above for handling a load instruction using a memory read buffer. The memory read buffer may include a field of a port number, rather than the field of an address of memory in FIG. 3 or 4.

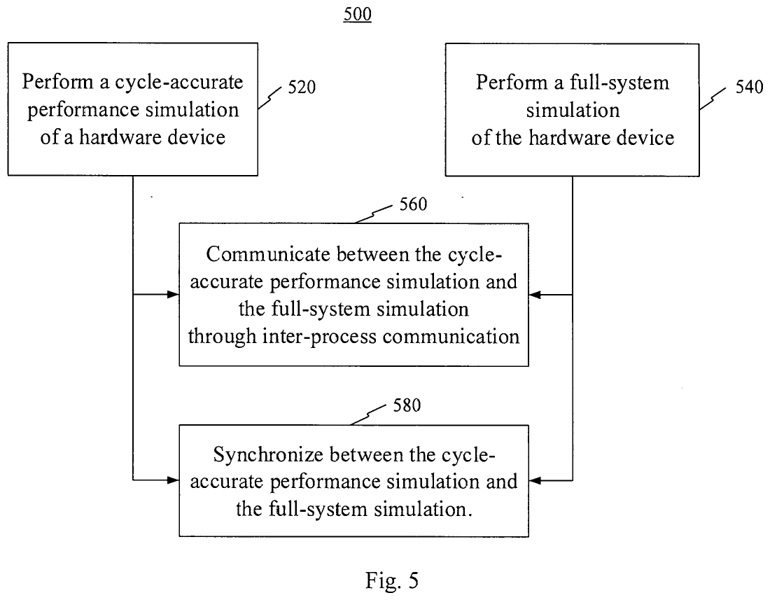

FIG. 5 is a flow chart of an exemplary method 500 for simulating full-system performance of a hardware device, according to some embodiments of the present disclosure. Method 500 can be performed by a full-system performance simulator (e.g., full-system performance simulator 100 of FIG. 1) and may include performing a cycle-accurate performance simulation of the hardware device (step 520), performing a full-system simulation of the hardware device (Step 540), communicating between the cycle-accurate performance simulation and the full-system simulation through inter-process communication (step 560), and synchronizing between the cycle-accurate performance simulation and the full-system simulation (step 580).

In step 520, a cycle-accurate performance simulation of the hardware device is performed. For example, as shown in FIG. 1, full-system performance simulator 100 of the CPU includes cycle-accurate performance simulator 120 and full-system simulator 140. Cycle-accurate performance simulator 120 includes a performance model 122, a functional model 124, and a transactor 126. Cycle-accurate performance simulator 120 can perform cycle-accurate performance simulations of the CPU in cycles in accordance with performance model 122.

In some embodiments, step 520 includes obtaining initial values of a plurality of registers in the cycle-accurate performance simulation. Before cycle-accurate performance simulator 120 starts to perform cycle-accurate performance simulation of the CPU, cycle-accurate performance simulator 120 may load initial contexts of registers of the CPU. For example, cycle-accurate performance simulator 120 may load initial values of general-purpose registers, segmentation registers, control registers, floating point registers, streaming SIMD single instruction multiple data (SIMD) extensions (SSE) registers, CPU identification (CPUID) registers, model-specific registers (MSRs) of the CPU.

In step 540, a full-system simulation of the hardware device is performed. For example, as shown in FIG. 1, full-system performance simulator 100 of the CPU includes cycle-accurate performance simulator 120 and full-system simulator 140. Full-system simulator 140 includes a CPU model 142, a disk model 143, a chipset model 144, a device model 145, a transactor 146, and a memory model 148. Full-system simulator 140 includes an entire system in which the CPU is applied to and models functionality of the entire system. Full-system simulation 140 includes an entire computer system that the simulated CPU is applied to. Accordingly, full-system simulator 140 can perform a full-system simulation of the CPU.

In some embodiments, step 540 further includes determining whether the received address of the instruction matches a first address of a buffer. In response to a determination that the received address of the instruction matches the first address of the buffer, communicating through inter-process communication in step 560 may include transmitting the fetched instruction through the second write pipe includes transmitting the instruction and another instruction in the buffer through the second write pipe. In response to a determination that the received address of the instruction does not match the first address of the buffer, communicating through inter-process communication in step 560 may include reading the instruction from memory in the full-system simulation in accordance with the address of the instruction.

For example, transactor 146 of full-system simulator 140 in FIG. 1 may include a buffer to store instructions that have been executed in the full-system simulation. When transactor 146 receives a request to fetch an instruction from transactor 126, transactor 146 may determine whether a PC of the instruction matches a PC in the first entry of the buffer. In response to a determination that the PC of the instruction matches the PC in the first entry of the buffer, transactor 146 may transmit all instructions stored in the buffer to transactor 126 of cycle-accurate simulator 120. In some embodiments, in response to the determination that the PC of the instruction matches the PC in the first entry of the buffer, transactor 146 may transmit the instruction and another instruction stored in the buffer to transactor 126 of cycle-accurate simulator 120.

In response to a determination that the received PC of the instruction does not match the PC in the first entry of the buffer, transactor 146 may read the instruction from memory of full-system simulator 140 in accordance with an address of the instruction and send to transactor 126. For example, transactor 146 may read the instruction from memory model 148 shown in FIG. 1.

In step 560, communication between the cycle-accurate performance simulator and the full-system simulator through inter-process communication is performed. For example, as shown in FIG. 1, full-system performance simulator 100 of the CPU includes cycle-accurate performance simulator 120 and full-system simulator 140. Cycle-accurate performance simulator 120 and full-system simulator 140 may respectively perform cycle-accurate performance simulation of the CPU and full-system simulation of the CPU by different processes in an operating system. Transactors 126 of cycle-accurate performance simulator 120 and transactor 146 of full-system simulator 140 can communicate with each other through inter-process communication (IPC) mechanisms, including shared memory, pipes, and a portable operating system interface (POSIX). The shared memory may be, for example, a shared memory space used for handshaking between transactors 126 and 146. Both transactors 126 and 146 can access the shared memory space. The pipes may be used for massive data transmission between transactors 126 and 146, such as instructions or application data transmission between cycle-accurate performance simulator 120 and full-system simulator 140. The POSIX may be used to send requests or responses between transactors 126 and 146.

In some embodiments, communicating between the cycle-accurate performance simulation and the full-system simulation through the inter-process communication in step 560 may include transmitting data through a plurality of pipes between the cycle-accurate performance simulation and the full-system simulation, accessing a shared memory between the cycle-accurate performance simulation and the full-system simulation; and communicating a request or a response through a portable operating system interface (POSIX) between the cycle-accurate performance simulation and the full-system simulation.

For example, as shown in FIG. 1, when cycle-accurate performance simulator 120 performs cycle-accurate performance simulation of the CPU and fetches an instruction from full-system simulator 140, transactor 126 may write a program counter (PC) of the instruction into a write pipe, e.g., a first write pipe. Transactor 126 may also set a request type as being FetchInst in the shared memory. Transactor 126 may further send a signal through the POSIX to transactor 146, and then spin on a synchronization pipe, e.g., a first synchronization pipe for synchronizing data transmission in the first write pipe.

On the other hand, transactor 146 may read the request type, e.g., FetchInst, from the shared memory and extract the fetch PC from the first write pipe. When the signal through the POSIX arrives at transactor 146, transactor 146 may read a fetch block of the instruction from memory of the simulated computer system in accordance with the PC and the request type. Transactor 146 may write the fetch block of the instruction to a write pipe of transactor 146, e.g., a second write pipe. Transactor 146 may then send a message in the first synchronization pipe that transactor 126 spins on. After receiving the message, transactor 126 may stop spinning on the first synchronization pipe and read the fetch block of the instruction from the second write pipe. Transactor 126 may also send a message in a second synchronization pipe to notify transactor 146 that the sent fetch block has been received.

In step 580, synchronization between the cycle-accurate performance simulator and the full-system simulator is performed. For example, as shown in FIG. 2, cycle-accurate performance simulator 120 may perform the cycle-accurate performance simulation slower than that of full-system simulator 140. Accordingly, transactor 146 may request full-system simulator 140 to stop full-system simulation and to wait for cycle-accurate performance simulation after each of cores 241 and 242 executes a number of instructions. For example, transactor 146 may request full-system simulator 140 to stop and wait for cycle-accurate performance simulator 120 after cores 241 and 242 each execute N instructions. After cycle-accurate performance simulator 120 performs a plurality of clock cycles that amount to the 2N instructions executed by full-system simulator 140, cycle-accurate performance simulator 120 may catch up simulation progress with that of full-system simulator 140. Transactor 146 may request full-system simulator 140 to resume performing the full-system simulation for another amount of instructions, such as another 2N instructions.

In some embodiments, when step 520 includes executing an instruction to read data from memory, communicating through inter-process communication in step 560 includes sending a request from the cycle-accurate performance simulation to the full-system simulation, and step 540 includes reading the data from an entry of a buffer. The request includes a program-counter value and an address of the data. The entry of the buffer includes the program-counter value and the address of the data.

For example, as shown in FIG. 3, full-system performance simulator 100 may include memory read buffer 360 for storing a value, a PC, and an address that a load instruction refers to in memory of full-system simulator 140. When core 341 executes a load instruction to load a value of 1 from addr #1 to eax, e.g., ld eax,[addr #1], transactor 126 may send a ReadMemory request for the first load instruction to obtain a value of addr #1 for its cycle-accurate performance simulation. Transactor 126 may also send a PC and addr #1 to transactor 146. When transactor 146 serves the ReadMemory request, transactor 146 may read from memory read buffer 360 the value of addr #1 in accordance with the PC and addr #1. Accordingly, transactor 1460 of full-system simulator 140 may provide cycle-accurate performance simulator 120 the correct value of addr #1 for the load instruction using memory read buffer 360.

Alternatively, the request may include a port number, and the entries of memory read buffer 360 may include port numbers, instead of the address. Core 341 may execute a load instruction to load data from an input port, e.g., ld eax [port #21].

In some embodiments, when step 520 includes executing an instruction to read data from memory, communicating through inter-process communication in step 560 includes sending a request from the cycle-accurate performance simulation to the full-system simulation, and step 540 includes reading the data from an entry of a buffer. The request includes a program-counter value, an address of the data, and an instruction identity. The entry of the buffer includes the program-counter value, the address of the data, the instruction identity, and a squash bit. The squash bit is set to be a first value when performing the cycle-accurate performance simulation includes previously squashing the instruction. The first value of the squash bit may be, for example, a value of “1.”

For example, as shown in FIG. 4, full-system performance simulator 100 may assign each instruction in full-system performance simulation of the CPU a unique instruction identifier (UID) for identification among other instructions. Thus, cycle-accurate performance simulator 120 and full-system simulator 140 may respectively assign each instruction that the simulated CPU in their simulations is going to perform a UID. Alternatively, transactors 126 and 146 may respectively assign each instruction that the simulated CPU in their simulations is going to perform a UID. As shown in FIG. 4, memory read buffer 460 may include a UID field and a Kill field. When cycle-accurate performance simulator 120 simulates the CPU to perform an instruction, transactor 126 may send to transactor 146 a ReadMemory request, a UID of the instruction, a PC and an address of the memory. After transactor 146 receives the ReadMemory request, the PC, the address of the memory, and the UID, transactor 146 may check whether the received PC, address, and UID match those in the first entry of memory read buffer 460-1.

Transactor 146 may store the UID of the first load instruction as being 1 in the first entry of memory read buffer 460-1. After receiving the ReadMemory request, the PC, the address, and the UID of the first load instruction, transactor 146 may determine whether the received PC, address, and UID match those in the first entry of memory read buffer 460-1. When transactor 146 determines that the received PC, address, UID matches those in the first entry of memory read buffer 460-1, transactor 146 may read the value of 1 from the first entry of memory read buffer 460-1 and send to transactor 126.

When cycle-accurate performance simulator 120 squashes the first load instruction, transactor 126 may send a message to transactor 146 to set a Kill field of the first entry of memory read buffer 460 as memory read buffer 460-1. The message may include a UID of the first load instruction. When transactor 146 receives another ReadMemory request, a PC, an address, and a UID, transactor 146 may check these parameters and the Kill field of the first entry of memory read buffer 460. Transactor 146 may read a value from the first entry of memory read buffer 460 if the received PC, address, and UID match those in the first entry and the Kill field of the first entry is set. The Kill field may be implemented as a squash bit in entries of memory read buffer 460. When cycle-accurate performance simulator 120 squashes an instruction in cycle-accurate performance simulation of the CPU, transactor 126 of cycle-accurate performance simulator 120 may send a message to set the squash bit to a value of 1.

For example, as shown in FIG. 4, when cycle-accurate performance simulator 120 squashes the first load instruction and re-execute it, transactor 146 may read the value of 1 from the first entry of memory read buffer 460-2 because the Kill field of the first entry of memory read buffer 460-2 is set. After transactor 146 reads the value from the first entry and sends to transactor 126, transactor 146 may reset the Kill bit in the first entry of memory read buffer 460-2. Accordingly, memory read buffer 460 may include contexts as shown in memory read buffer 460-3.

When cycle-accurate performance simulator 120 commits the first load instruction, transactor 126 may send a message including the UID of the first load instruction to transactor 146. Transactor 146 may de-allocate the first entry of memory read buffer 460-3 after transactor 146 determines the received UID matches the UID of the first entry. Accordingly, the contexts of memory read buffer 460 may change from memory read buffer 460-3 to memory read buffer 460-4.

In some embodiments, when step 540 further includes detecting an interrupt, communicating through inter-process communication in step 560 includes sending an interrupt-occurrence message from the full-system simulation to the cycle-accurate performance simulation, and step 520 includes updating a program counter in the cycle-accurate performance simulation in accordance with the interrupt-occurrence message. Detecting an interrupt may further include parsing an interrupt descriptor table, extracting a program-counter value of an interrupt handler corresponding to the interrupt, and determining whether the interrupt occurs in accordance with a program-counter value in the full-system simulation and the program-counter value of the interrupt handler.

For example, when an interrupt occurs in the full-system simulation of the CPU, full-system simulator 140 may detect the interrupt and inform cycle-accurate performance simulator 120 to change an execution path in cycle-accurate performance simulation of the CPU. Cycle-accurate performance simulator 120 may change its execution path to a PC of an interrupt handler.

Accordingly, transactor 146 may parse an interrupt descriptor table (IDT) in memory, extract PCs of interrupt handlers and vectors for each interrupt registered by an operating system (OS) and store them in an IDT list. When full-system simulator 140 performs a simulation of the CPU to execute an instruction, transactor 146 may compare a PC of the executed instruction with one or more of PCs in the IDT list. When the PC of the executed instruction matches one of PCs in the IDT, transactor 146 may determine that an interrupt occurs. Thus, transactor 146 may send an interrupt-occurrence message to notify transactor 126 for handling the interrupt. The interrupt-occurrence message may indicate that an interrupt occurs when the CPU executes the instruction. In some embodiments, transactor 146 may send the interrupt occurrence message along with a next FetchInst request to transactor 126.

In some embodiments, when step 540 includes detecting an input-output (I/O) access, communicating through inter-process communication in step 560 includes sending an I/O access message from the full-system simulation to the cycle-accurate performance simulation, and step 520 includes updating a program counter in the cycle-accurate performance simulation in accordance with the I/O access message.

For example, when full-system simulator 140 performs a full-system simulation of the CPU and needs input or output (I/O) access in the full-system simulation of the CPU, transactor 146 may notify cycle-accurate performance simulator 120 the occurrence of the I/O access. Accordingly, transactor 146 may detect the I/O access occurred in the full-system simulation and sent a message to transactor 126 to notify cycle-accurate performance simulator 120. In some embodiments, transactors 126 and 146 may handle a memory-mapped I/O access by the methods shown in FIG. 3 or 4 and illustrated above for handling a load instruction using a memory read buffer.

In some embodiments, transactors 126 and 146 may also handle an I/O access through a port by the methods shown in FIG. 3 or 4 and illustrated above for handling a load instruction using a memory read buffer. The memory read buffer may include a field of a port number, rather than the field of an address of the memory in FIG. 3 or 4.

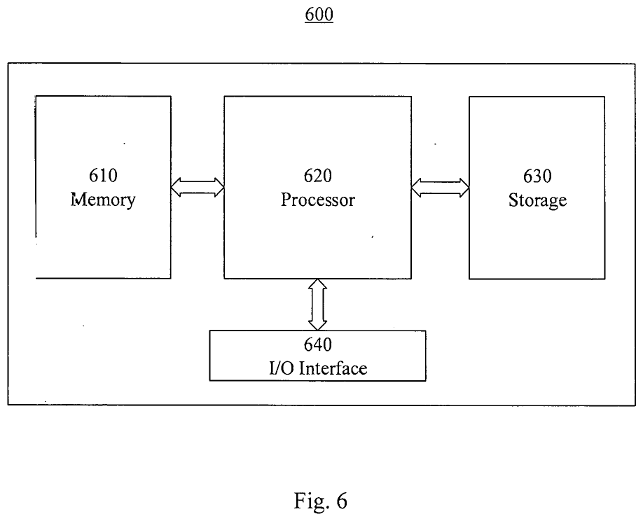

FIG. 6 illustrates a block diagram of an exemplary system 600 for simulating full-system performance of a hardware device, according to some embodiments of the present disclosure. System 600 may include a memory 610, a processor 620, a storage 630, and an input/output (I/O) interface 640.

Memory 610 may include any appropriate type of mass storage provided to store any type of information that processor 620 may need to operate. For example, memory 610 may include dynamic random-access memory (DRAM) and may be configured to be the main memory of system 600. In some embodiments, memory 610 may be a volatile or non-volatile, magnetic, semiconductor, tape, optical, removable, non-removable, or other type of storage device or tangible and/or non-transitory computer-readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, any other memory chip or cartridge, and networked versions of the same.

In some embodiments, memory 610 may be configured to store one or more computer programs that may be executed by processor 620 to perform full-system performance simulation methods disclosed in this application. For example, memory 610 may be configured to store program(s) that may be executed by processor 620 to perform full-system performance simulations, as described in the present disclosure.

In some embodiments, memory 610 may also be configured to store information and data for processor 620 to access. For example, memory 110 may be configured to store performance model 122, functional model 124, chipset model 144, disk model 143, device model 145, or memory model 148 that processor 620 may access when performing full-system performance simulations.

Processor 620 can include a microprocessor, digital signal processor, controller, or microcontroller. Processor 120 may be configured to perform a cycle-accurate performance simulation of the hardware device. For example, as shown in FIG. 1, processor 620 may be configured to perform full-system performance simulation of the CPU including cycle-accurate performance simulation and full-system simulation. Processor 620 may be configured to perform cycle-accurate performance simulation includes performance model 122, functional model 124, and transactor 126.

Processor 620 may also be configured to perform a full-system simulation of the hardware device. For example, as shown in FIG. 1, processor 620 may be configured to perform full-system performance simulation of the CPU including cycle-accurate performance simulation and full-system simulation. The full-system simulation includes CPU model 142, disk model 143, chipset model 144, device model 145, transactor 146, and memory model 148. Processor 620 may be configured to perform full-system simulation including an entire system in which the CPU is applied to and modeling functionality of the entire system in accordance with CPU model 142, disk model 143, chipset model 144, device model 145, transactor 146, and memory model 148.

Processor 620 may further be configured to allow communications between the cycle-accurate performance simulation and the full-system simulation through inter-process communication. For example, as shown in FIG. 1, full-system performance simulator 100 of the CPU includes cycle-accurate performance simulator 120 and full-system simulator 140. Processor 620 may be configured to respectively perform cycle-accurate performance simulation of the CPU and full-system simulation of the CPU by different processes in an operating system. Processor 620 may also be configured to communicate between cycle-accurate performance simulation of the CPU and full-system simulation of the CPU through inter-process communication (IPC) mechanisms, including shared memory, pipes, and a portable operating system interface (POSIX).

Processor 620 may also be configured to synchronize between the cycle-accurate performance simulation and the full-system simulation. For example, as shown in FIG. 2, processor 620 may be configured to perform the cycle-accurate performance simulation that is slower than that of full-system simulation. Accordingly, processor 620 may be configured to request the full-system simulation to stop and wait for cycle-accurate performance simulation after each of cores 241 and 242 executes a number of instructions. For example, processor 620 may be configured to request full-system simulation to stop and wait for cycle-accurate performance simulation after cores 241 and 242 each execute N instructions. After cycle-accurate performance simulation is performed a plurality of clock cycles that amount to the 2N instructions, cycle-accurate performance simulation may catch up simulation progress with that of full-system simulation. Processor 620 may be configured to request full-system simulation to resume simulation for another amount of instructions, such as another 2N instructions.

Processor 620 can be configured by one or more programs stored in memory 610 and/or storage 630 to perform operations described above with respect to the methods shown in FIGS. 1-5.

Storage 630 may include any appropriate type of mass storage provided to store any type of information that processor 620 may need to operate. Storage 630 may be a volatile or non-volatile, magnetic, semiconductor, tape, optical, removable, non-removable, or other type of storage device or tangible and/or non-transitory computer-readable medium. Storage 630 may be configured to store one or more computer programs that may be executed by processor 620 to perform exemplary full-system performance simulation methods disclosed in this application. For example, storage 630 may be configured to store program(s) that may be executed by processor 620 to perform full-system performance simulations, as described above.

I/O interface 640 may be configured to facilitate the communication between system 600 and other apparatuses. For example, I/O interface 640 may be configured to receive data or instructions from another apparatus, e.g., another computer. I/O interface 640 may also be configured to output data or instructions to other apparatuses, e.g., a laptop computer or a speaker.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

1. A system for simulating full-system performance of a hardware component, the system comprising:
a cycle-accurate performance simulator configured to model a performance of the hardware component of a plurality of hardware components of an application system, the cycle-accurate performance simulator including a first transactor;
a full-system simulator configured to model a performance of the plurality of hardware components of the application system, the full-system simulator including a second transactor; and
a communication mechanism between the first transactor and the second transactor, wherein the communication mechanism is configured to communicate data between the cycle-accurate performance simulator and the full-system simulator.

2. The system of claim 1, wherein the communication mechanism is configured to:
transmit the data through a plurality of pipes between the cycle-accurate performance simulator and the full-system simulator;
access a shared memory between the cycle-accurate performance simulator and the full-system simulator; and
communicate a request or a response through a portable operating system interface (POSIX) between the cycle-accurate performance simulator and the full-system simulator.

3. The system of claim 2, wherein the plurality of pipes includes:
a first write pipe from the cycle-accurate performance simulator to the full-system simulator;
a first synchronization pipe associated with the first write pipe;
a second write pipe from the full-system simulator to the cycle-accurate performance simulator; and
a second synchronization pipe associated with the second write pipe.

4. The system of claim 3, wherein:
the cycle-accurate performance simulator is further configured to:
request to fetch an instruction, and
receive the instruction;
the communication mechanism is further configured to:
transmit an address of the instruction through the first write pipe,
set a request type to be an instruction-fetch type in the shared memory,
send a request signal through the POSIX from the cycle-accurate performance simulator to the full-system simulator, and
transmit a fetched instruction through the second write pipe; and
the full system simulator is further configured to:
fetch the instruction in accordance with the address of the instruction and the request type, and
send the fetched instruction.

5. The system of claim 4, wherein the full-system simulator is further configured to:
determine whether the received address of the instruction matches a first address of a buffer,
wherein responsive to a determination that the received address of the instruction matches the first address of the buffer, the communication mechanism is further configured to transmit another instruction in the buffer through the second write pipe.

6. The system of claim 5, wherein responsive to a determination that the received address of the instruction does not match the first address of the buffer, the full-system simulator is further configured to:
read the instruction from a memory in the full-system simulator in accordance with the address of the instruction.

7. The system of claim 1, wherein the full-system simulator is further configured to:
synchronize with the cycle-accurate performance simulator.

8. The system of claim 7, wherein the full-system simulator is further configured to:
after the full-system simulator performs full-system simulation through a first plurality of instructions, stop performing the full-system simulation, and
after the cycle-accurate performance simulator performs cycle-accurate performance simulation through a plurality of cycles, resume performing the full-system simulation.

9. The system of claim 1, wherein the cycle-accurate performance simulator is configured to obtain initial values of a plurality of registers in the cycle-accurate performance simulator.

10. The system of claim 1, wherein:
when the cycle-accurate performance simulator is configured to execute an instruction to read data from a memory,
the communication mechanism is configured to send a first request from the cycle-accurate performance simulator to the full-system simulator, wherein the first request includes a program-counter value and an address of the data; and
the full-system simulator is configured to read the data from an entry of a buffer, wherein the entry includes the program-counter value and the address of the data.

11. The system of claim 1, wherein:
when the cycle-accurate performance simulator is configured to execute an instruction to read data from a memory,
the communication mechanism is configured to send a second request from the cycle-accurate performance simulator to the full-system simulator, wherein the second request includes a program-counter value, an address of the data, and an instruction identity; and
the full-system simulator is configured to read the data from an entry of a buffer, wherein the entry includes the program-counter value, the address of the data, the instruction identity, and a squash bit,
wherein the squash bit is set to be a first value when the cycle-accurate performance simulation previously squashes the instruction.

12. The system of claim 11, wherein:
when the cycle-accurate performance simulator previously squashes the instruction,
the communication mechanism is configured to send a setting message to set the squash bit to be the first value from the cycle-accurate performance simulator to the full-system simulator, wherein the setting message includes the instruction identity.

13. The system of claim 1, wherein:
when the full-system simulator is configured to detect an interrupt,
the communication mechanism is configured to send an interrupt-occurrence message from the full-system simulator to the cycle-accurate performance simulator; and
the cycle-accurate performance simulator is configured to update a program counter in the cycle-accurate performance simulator in accordance with the interrupt-occurrence message.

14. The system of claim 13, wherein the full-system simulator is configured to detect the interrupt, the full-system simulator being further configured to:
parse an interrupt descriptor table;
extract a program-counter value of an interrupt handler corresponding to the interrupt; and
determine whether the interrupt occurs in accordance with a program-counter value in the full-system simulator and the program-counter value of the interrupt handler.

15. The system of claim 1, wherein:
when the full-system simulator is configured to detect an input-output (I/O) access,
the communication mechanism is configured to send an I/O access message from the full-system simulator to the cycle-accurate performance simulator; and
the cycle-accurate performance simulator is configured to update a program counter in the cycle-accurate performance simulator in accordance with the I/O access message.

16. A method for simulating full-system performance of a hardware device, the method comprising:
performing a cycle-accurate performance simulation of the hardware device;
performing a full-system simulation of the hardware device; and
communicating between the cycle-accurate performance simulation and the full-system simulation through inter-process communication.

17-21. (canceled)

22. The method of claim 16, further comprising:
synchronizing between the cycle-accurate performance simulation and the full-system simulation, wherein synchronizing between the cycle-accurate performance simulation and the full-system simulation includes:
after performing the full-system simulation through a first plurality of instructions, stopping performing the full-system simulation, and
after performing the cycle-accurate performance simulation through a plurality of cycles, resuming performing the full-system simulation.

23. (canceled)

24. (canceled)

25. The method of claim 16, wherein:
performing the cycle-accurate performance simulation includes executing an instruction to read data from a memory;
communicating between the cycle-accurate performance simulation and the full-system simulation through inter-process communication includes sending a first request from the cycle-accurate performance simulation to the full-system simulation, wherein the first request includes a program-counter value and an address of the data; and
performing the full-system simulation includes reading the data from an entry of a buffer, wherein the entry includes the program-counter value and the address of the data.

26. The method of claim 16, wherein:
performing the cycle-accurate performance simulation includes executing an instruction to read data from a memory;
communicating between the cycle-accurate performance simulation and the full-system simulation through inter-process communication includes sending a second request from the cycle-accurate performance simulation to the full-system simulation, wherein the second request includes a program-counter value, an address of the data, and an instruction identity; and
performing the full-system simulation includes reading the data from an entry of a buffer, wherein the entry includes the program-counter value, the address of the data, the instruction identity, and a squash bit,
wherein the squash bit is set to be a first value when performing the cycle-accurate performance simulation includes previously squashing the instruction.

27-30. (canceled)

31. A non-transitory computer-readable medium storing a set of instructions that are executable by one or more processors of an apparatus to cause the apparatus to perform a method for simulating full-system performance of a hardware device, the method comprising:
performing a cycle-accurate performance simulation of the hardware device;
performing a full-system simulation of the hardware device; and
communicating between the cycle-accurate performance simulation and the full-system simulation through inter-process communication.
